(19) United States
(12) Patent Application Publication
(10) Pub. No.: US 2020/0348155 A1
(43) Pub. Date: Nov. 5, 2020

(54) STORING MEASUREMENTS OF NOZZLE CONDITIONS

(71) Applicant: HEWLETT-PACKARD DEVELOPMENT COMPANY, Spring, TX (US)

(72) Inventors: Daryl E. Anderson, Corvallis, OR (US); Eric Martin, Corvallis, OR (US)

(21) Appl. No.: 16/493,026

(22) PCT Filed: Jan. 17, 2018
(86) PCT No.: PCT/US2018/014046

§ 371 Date: Sep. 11, 2019

(51) Int. Cl. G01D 9/30; B05B 12/00; G01D 21/02

(52) U.S. Cl. CPC G01D 9/30; G01D 21/02; B05B 12/004

(57) ABSTRACT

In some examples, a fluid dispensing device includes storage elements, and a switch assembly comprising switches controllable by control signals responsive to a given fire event that activates a nozzle of the fluid dispensing device to provide a first sense measurement of a first condition of the nozzle to a first storage element of the storage elements, and provide a second sense measurement of a different second condition of the nozzle to a second storage element of the storage elements.

### BACKGROUND

A fluid dispensing system can dispense fluid towards a target. In some examples, a fluid dispensing system can include a printing system, such as a two-dimensional (2D) printing system or a three-dimensional (3D) printing system. A printing system can include printhead devices that include nozzles for dispensing printing fluids.

### BRIEF DESCRIPTION OF THE DRAWINGS

Some implementations of the present disclosure are described with respect to the following figures.

FIG. 1 is a block diagram of a fluid dispensing device, according to some examples.

FIGS. 2A-2E illustrate an example operation of a nozzle that is coupled to a multi-measurement sample and hold circuit according to some examples.

FIG. 3 is a graph illustrating plots of sensor measurements with respect to time, in accordance with some examples.

FIG. 4 is a block diagram of a drive bubble detection (DBD) measurement circuit, according to further examples.

FIG. 5 is a flow diagram of a process of a DBD controller, according to further examples.

FIG. 6 is a block diagram of a printhead die, according to other examples.

FIG. 7 is a block diagram of a system according to additional examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A fluid dispensing device has nozzles through which a fluid can be dispensed. The fluid dispensing device further includes fluid actuators that when activated cause the dispensing of the fluid from the respective nozzles. Activating a fluid actuator of a nozzle to cause dispensing of a fluid from the nozzle can also be referred to as firing the nozzle. In some examples, the fluid actuators include thermal-based fluid actuators including heating elements, such as resistive heaters. When a heating element is activated, the heating element produces heat that can cause vaporization of a fluid to cause nucleation of a vapor bubble (e.g., a steam bubble) proximate the thermal-based fluid actuator that in turn causes ejection of a quantity of fluid from an orifice of a nozzle. In other examples, a fluid actuator may be a piezoelectric membrane based fluid actuator that when activated applies a mechanical force to eject a quantity of fluid from an orifice of a nozzle.

Each nozzle includes a fluid chamber, also referred to as a firing chamber. In addition, a nozzle can include an orifice through which fluid is dispensed, a fluid actuator, and a sensor. Each fluid chamber provides the fluid to be dispensed by the respective nozzle. Prior to a droplet release, the fluid in the fluid chamber is restrained from exiting the nozzle due to capillary forces and/or back-pressure acting on the fluid within the nozzle passage.

During a droplet release from a nozzle, the fluid within the fluid chamber is forced out of the nozzle by actively increasing the pressure within the fluid chamber. In some example fluid dispensing devices, a resistive heater positioned within the fluid chamber when activated vaporizes a small amount of at least one component of the fluid. In some cases, a major component of the fluid (such as liquid ink for printing systems or other types of fluids) is water, and the resistive heater vaporizes the water. The vaporized fluid component expands to form a gaseous drive bubble within the fluid chamber. This expansion exceeds a restraining force on the fluid within the fluid chamber enough to expel a quantity of fluid (a single fluid droplet or multiple fluid droplets) out of the nozzle. Generally, after the release of fluid droplet, the pressure in the fluid chamber drops below the strength of the restraining force and the remainder of the fluid is retained within the fluid chamber. Meanwhile, the drive bubble collapses and fluid from a reservoir for the fluid dispensing device flows into the fluid chamber to replenish the lost fluid volume resulting from the fluid droplet release. The foregoing process is repeated each time the nozzle of the fluid dispensing device is instructed to fire.

After repeated use of the nozzles of a fluid dispensing device, the nozzles may develop defects (e.g., a nozzle may become clogged, a resistive heater may malfunction, etc.) and hence may not operate in a target manner. As a result, fluid dispensing performance of the nozzles may degrade over time and use.

In some examples, nozzle health can be determined by performing drive bubble detection (DBD) measurements at each nozzle. DBD measurements can allow for detection of degradation of nozzles, so that servicing or replacement of a fluid dispensing device can be performed.

A fire event can refer to a signal or other indication that is provided to activate a nozzle. A fire event to activate a nozzle can refer to a fire event to activate a single nozzle or a group of nozzles. In some examples, a DBD measurement of a nozzle is performed in response to a fire event. In some cases, to obtain multiple DBD measurements of a nozzle, the nozzle would have to be fired multiple times in response to respective multiple fire events.

Firing a nozzle multiple times to obtain respective DBD measurements can increase the amount of time involved in evaluating the health of the nozzle. Moreover, each firing of a nozzle consumes power and generates heat. In some cases, firing a nozzle to perform a nozzle health evaluation can cause ejection of a fluid droplet, which leads to increased fluid usage. Also, in printing applications, ejection of a fluid droplet during nozzle health evaluation can lead to the fluid droplet being deposited onto a print medium or other print target, which may be undesirable since the fluid droplet can cause a noticeable artifact on the print medium or other print target.

In accordance with some implementations of the present disclosure, a fluid dispensing device includes a sample and hold circuit that allows multiple measurements of a nozzle to be made in response to a given individual fire event that fires the nozzle. In other words, rather than obtaining multiple nozzle measurements (of a nozzle) based on using multiple fire events, just one individual fire event can be provided to the activate the nozzle and to obtain the multiple nozzle measurements. Note that the measurements of the nozzle can be obtained in response to activation of either a thermal-based fluid actuator, a piezoelectric membrane based fluid actuator, or any other type of fluid actuator.

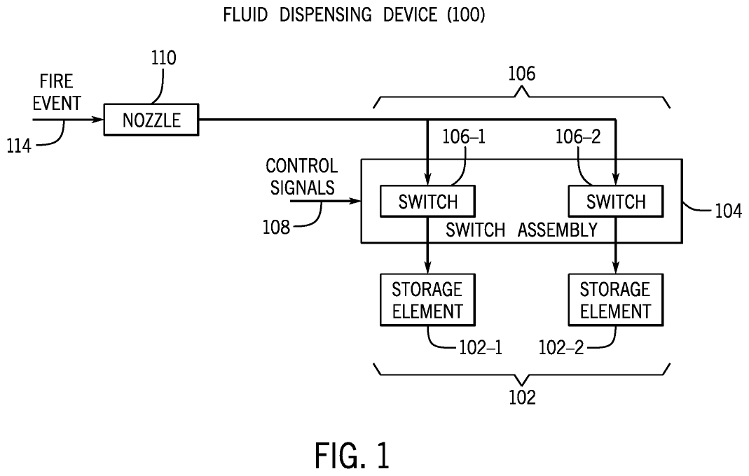

FIG. 1 is a block diagram of a fluid dispensing device 100. In some examples, the fluid dispensing device 100 can be a fluid dispensing die. A “die” refers to an assembly where various layers are formed onto a substrate to fabricate circuitry, including a nozzle 110, a switch assembly 104, and storage elements 102 (102-1 and 102-2 shown in FIG. 1).

The fluid dispensing device 100 in some examples can be a printhead device (such as a printhead die). A printhead device is to dispense printing fluid from the nozzles of the printhead device, such as for use in two-dimensional (2D) or three-dimensional (3D) printing systems. In a 2D printing system, the printing fluid can include ink dispensed by a printhead device onto a print medium, such as a paper medium, a plastic medium, and so forth.

In a 3D printing system, various different printing fluids can be dispensed by a printhead device. The printing fluids that can be dispensed by a printhead device in a 3D printing system can include any or some combination of the following: ink, an agent used to fuse powders of a layer of build material, an agent to detail a layer of build material (such as by defining edges or shapes of the layer of build material), and so forth. In a 3D printing system, a 3D target is built by depositing successive layers of build material onto a build platform of the 3D printing system. Each layer of build material can be processed using the printing fluid from a printhead device to form the desired shape, texture, and/or other characteristic of the layer of build material.

Although reference is made to printing systems in some examples, it is noted that techniques or mechanisms of the present disclosure are applicable to other types of fluid dispensing systems used in non-printing applications that are able to dispense fluids through nozzles of fluid dispensing devices. Examples of such other types of fluid dispensing systems include those used in fluid sensing systems, medical systems, vehicles, fluid flow control systems, and so forth.

The storage elements 102 (102-1 and 102-2 shown) are to store measurement data measured by a sensor at a nozzle 110 of the fluid dispensing device 100.

The fluid dispensing device 100 further includes a switch assembly 104 that has switches 106 (106-1 and 106-2 shown) controllable by control signals 108. The control signals 108 are responsive to a given fire event 114 that activates the nozzle 110 of the fluid dispensing device 100. The control signals 108 are able to selectively activate and deactivate the switches 106 of the switch assembly 104.

The switch 106-1 can be activated by the control signals 108 to provide a first sense measurement of a first condition of the nozzle 110 to the first storage element 102-1, and the switch 106-2 can be activated by the control signals 108 to provide a second sense measurement of a different second condition of the nozzle 110 to the second storage element 102-2.

Although just two storage elements 102-1 and 102-2 and respective switches 106-1 and 106-2 are shown in FIG. 1, it is noted that in other examples, there can be more than two storage elements and respective additional switches. Also, the switch assembly 104 can also include other switches (discussed further below) to control the output of measurement data stored at the storage elements 102 to an output circuit.

The switch assembly 104 and the storage elements 102 collectively can be referred to as a “multi-measurement sample and hold circuit.” In accordance with some implementations of the present disclosure, the multi-measurement sample and hold circuit is able to store multiple sense measurements corresponding to different conditions of the nozzle 110 in response to a single fire event. As a result, to obtain sense measurements for different conditions of the nozzle 110, multiple fire events do not have to be provided, which increases the speed at which the measurements can be obtained for purposes of evaluating the health of the nozzle 110, and reduces power consumption and heat generation associated with health evaluations. Also, the amount of fluids dispensed by the nozzle 110 as part of performing a health evaluation of the nozzle 110 is reduced since just one fire event is used to make multiple nozzle measurements.

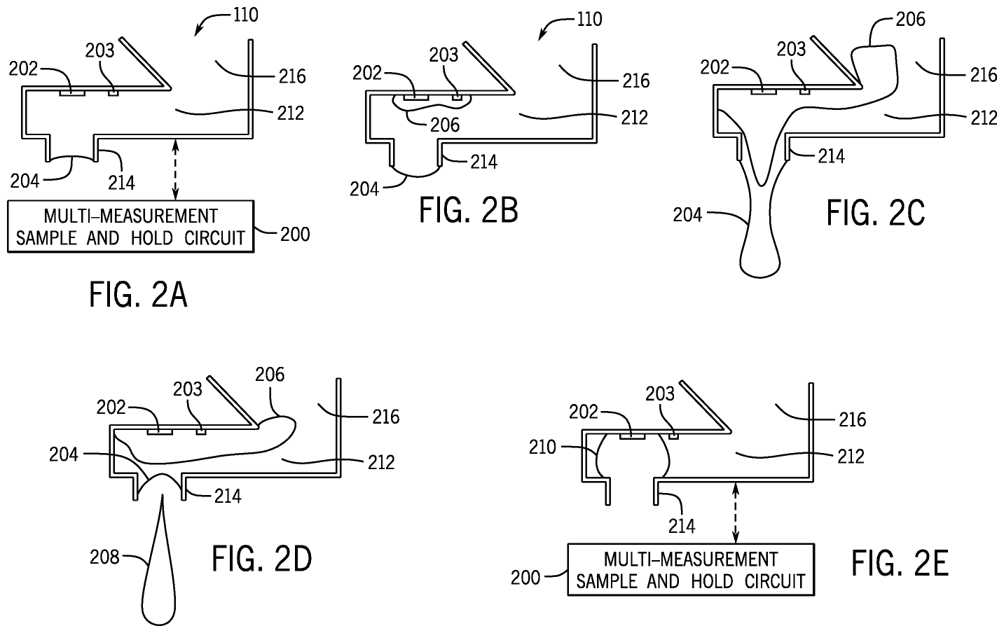

FIGS. 2A-2E show operation of the nozzle 110 that is coupled to an example multi-measurement sample and hold circuit 200. The multi-measurement sample and hold circuit 200 can include a switch assembly 104 and the storage elements 102 of FIG. 1, in accordance with some examples.

FIGS. 2A-2E illustrate an example of formation and collapse of a drive bubble (a vapor bubble) in the nozzle 110 in response to activation of a thermal based fluid actuator that includes a resistive heater 202 in the nozzle 110. In addition, the nozzle 110 includes a sensor 203. The sensor 203 is a fluid property sensor to measure a fluid property. When disposed in a nozzle, a sensor can be referred to as a nozzle sensor to measure a fluid property concurrent with actuation of the fluid actuator. In examples where the fluid actuator is a thermal based fluid actuator, the nozzle sensor can be used (via sense circuits) to sense a fluid property during formation and collapse of a vapor bubble. FIGS. 2A-2E refer to such an example.

In other examples where the fluid actuator is a piezoelectric membrane based fluid actuator, the nozzle sensor may be used (via sense circuits) to sense a fluid property during actuation of the piezoelectric membrane that causes ejection of a quantity of fluid from the nozzle.

In some examples, the sensor 203 can be an impedance sensor to measure variations in the impedance associated with the nozzle 110 due to formation of a drive bubble 206, as shown in FIGS. 2B-2C. In other examples, other types of sensors can be used to measure characteristics of the nozzle 110 due to formation of the drive bubble 206.

Although FIGS. 2A-2E illustrate the resistive heater 202 and the sensor 203 as being separated from one another along a horizontal direction, in other examples, it is noted that the resistive heater 202 and the sensor 203 can be stacked one over the other. In the stacked arrangement, an insulating layer, such as an oxide layer, can be provided between the resistive heater 202 and the sensor 203, with the sensor 203 in contact with the fluid in a fluid chamber 212 but the resistive heater 202 isolated from the fluid chamber 212.

The fluid chamber 212 of the nozzle 110 contains the fluid that is to be ejected by the nozzle 110. In response to a voltage applied to the resistive heater 202 as part of a fire event, a current flows through the resistive heater 202 and heats up a resistive material of the resistive heater 202.

Prior to activation of the resistive heater 202, the fluid of the nozzle 110 is retained within the fluid chamber 212 due to capillary action, with a fluid level (indicated by 204) contained within the fluid chamber 212. In response to receiving a fire event that causes the resistive heater 202 to heat up the fluid in the fluid chamber 212, vaporization of the fluid starts to form a drive bubble 206 that is depicted in FIG. 2B. The initially formed drive bubble 206 continues to expand and force the fluid level 204 to extend beyond an output orifice 214 of the nozzle 110, as shown in FIG. 2C.

In some examples, the fluid in the fluid chamber 212 can be a relatively good conductor of electrical current. Consequently, the electrical impedance of the fluid within the fluid chamber 212 can be relatively low. As the nozzle 110 prepares for dispensing a fluid droplet, prior to formation of the drive bubble 206 as shown in FIG. 2A, the sensor 203 can be activated to pass an electrical current through the fluid within the fluid chamber 212. The electrical impedance associated with the fluid chamber 212 can be measured by the sensor 203.

As the drive bubble 206 forms due to action of the heater 202, the fluid in the proximity of the sensor 203 may lose contact with the sensor 203. As the drive bubble 206 forms, the sensor 203 may be completely surrounded by the drive bubble 206, as shown in FIGS. 2B-2C. At this stage, since the sensor 203 is not in contact with the fluid, the impedance measured by the sensor 203 increases.

When the drive bubble 206 is at its “peak,” as shown in FIG. 2C, the impedance measured by the sensor 203 can be at its maximum. The drive bubble 206 being at its peak can refer to a condition of the drive bubble 206 when the drive bubble 206 has its largest extent in the fluid chamber 212 in response to heating produced by the heater 202.

A first sense measurement that can be stored by the multi-measurement sample and hold circuit 200 in response to a given fire event can correspond to a measurement when the drive bubble 206 is at its peak.

As the drive bubble 206 expands to the extent shown in FIG. 2C, the physical forces that retain the fluid within the fluid chamber 212 may no longer be able to hold the fluid level 204. As a result, a fluid droplet 208 is formed that separates from the orifice 214 of the nozzle 110, as shown in FIG. 2D. The separated fluid droplet 208 is ejected towards a target. Note that in some cases, multiple fluid droplets 208 may be formed.

At the time that the fluid droplet 208 is ejected, prior to ejection of the fluid droplet 208, or after the ejection of the fluid droplet 208, the resistive heater 202 is deactivated. As a result, the fluid chamber 212 can be replenished with additional fluid flowing from a reservoir (not shown) that passes through a flow channel 216 of the nozzle 110. As the fluid is replenished, the drive bubble 206 collapses to form a space 210, thereby restoring fluid contact with the sensor 203, as shown in FIG. 2E. Once the fluid in the fluid chamber 212 is contacted again to the sensor 203, the impedance measured by the sensor 203 decreases.

At this time when the drive bubble 206 has collapsed and the fluid chamber 212 has re-filled with fluid, the multi-measurement sample and hold circuit 200 can store another sense measurement (referred to as a “reference measurement”) from the sensor 203.

Thus, the sensed measurements stored by the multi-measurement sample and hold circuit 200 include a first “peak” measurement taken by the sensor 203 when the drive bubble 206 is at its peak (i.e., the impedance is largest due to loss of contact between the sensor 203 and the fluid and of the nozzle 110) and a reference measurement when the drive bubble 206 has collapsed and the fluid chamber 212 has re-filled.

More generally, the sensed measurements can include a first measurement taken in a first state of the nozzle, and a second measurement taken in a different second state of the nozzle. Even more generally, the sensed measurements can include multiple measurements (two or more) taken at respective corresponding states of the nozzle.

The peak measurement and the reference measurement can be taken at respective different relative time periods from the given individual fire event. More specifically, the peak measurement can be stored by the multi-measurement sample and hold circuit 200 a first time period from the given fire event, and the reference measurement can be stored by the multi-measurement sample and hold circuit 200 at a different second time period (different from the first time period) from the given fire event.

The first and second relative time periods can be programmed into a controller that controls the control signals 108 provided to the switch assembly 104 (FIG. 1) of the multi-measurement sample and hold circuit 200. The peak measurement can then be compared with the reference measurement, and the difference between the peak measurement and the reference measurement can provide an indication of whether or not the nozzle 110 is healthy. Further, in the case where the measurements (or difference between the measurements) indicates a poorly performing nozzle, an evaluation of each of the two (or more) measurements (without having to rely on other data) can indicate the nature of the defect.

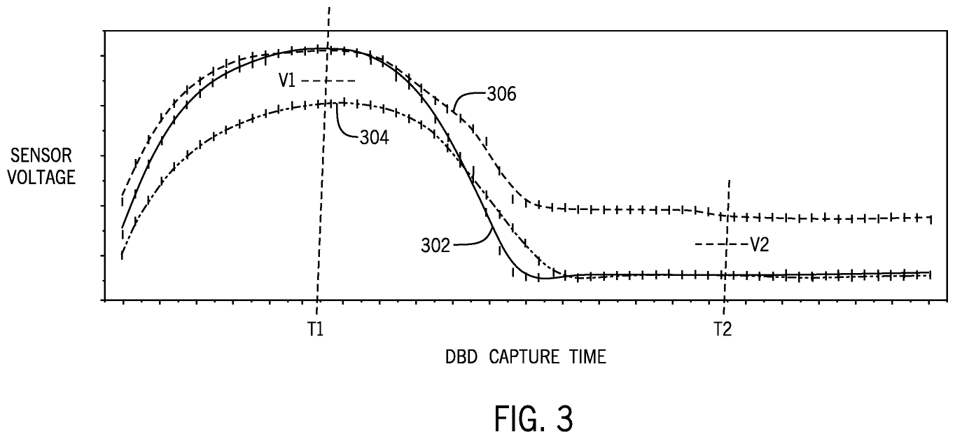

FIG. 3 is a graph showing plots of sensor voltages (as measured by the sensor 203 shown in FIGS. 2A-2E). In examples where the sensor 203 is an impedance sensor, the sensor voltage output by the sensor 203 represents the impedance measured by the sensor 203.

A curve 302 including various sensor voltages over time represents sensor measurements for a healthy nozzle. A curve 304 including sensor voltages over time represents measurements for a nozzle that has a blocked (fully blocked or partially blocked) output orifice (214) in FIGS. 2A-2E. A curve 306 including sensor voltages over time represents measurements of a nozzle where the inlet channel 216 to the fluid chamber 212 is blocked (fully blocked or partially blocked).

In some examples, a peak measurement can be taken at time T1, and a reference measurement can be taken at time T2. A comparison of the reference measurement at time T1 to the reference measurement at time T2 can provide an indication of the health condition of the nozzle, i.e., whether the nozzle is healthy or the nozzle is experiencing a blockage condition (either blockage at the output orifice 214 or blockage at the inlet channel 216).

In some examples, comparing the peak measurement to the reference measurement can include computing a difference between the peak measurement and the reference measurement. As shown in FIG. 3, the difference between the peak measurement and the reference measurement on the curve 302 (healthy nozzle) is larger than the difference between the peak measurement and the reference measurement on either curve 304 or 306 (blocked orifice or blocked inlet, respectively). Thus, a healthy nozzle is indicated if the difference between the peak measurement and the reference measurement is greater than a specified threshold, and a defective nozzle is indicated if the difference between the peak measurement and the reference measurement is less than the specified threshold.

In other examples, instead of comparing the peak measurement to the reference measurement, the measurements taken at multiple time points can be compared to predefined values for determining the health condition of the nozzle.

For example, the peak measurement taken at time T1 can be compared to a threshold voltage V1, and the reference measurement taken at time T2 can be compared to a threshold voltage V2 (different from V1). Table 1 below sets forth how relations between the peak measurement to V1 and the reference measurement to V2 represent respective different conditions of a nozzle.

TABLE 1

| | | Blocked output | Blocked inlet |
|---|---|---|---|
| | Healthy nozzle | orifice | channel |
| Peak measurement | >V1 | <V1 | >V1 |
| at T1 | | | |
| Reference | <V2 | <V2 | >V2 |
| measurement at T2 | | | |

According to Table 1, if the peak measurement is greater than V1 and the reference voltage is less than V2, then a healthy nozzle is indicated. However, if the peak measurement is less than V1 and the reference voltage is less than V2, then a nozzle with a blocked output orifice is indicated. If the peak measurement is greater than V1 and the reference voltage is greater than V2, then a nozzle with a blocked inlet channel is indicated.

The foregoing provides some examples of how multiple measurements of a nozzle made in response to a single fire event can be used to determine a condition of the nozzle. In other examples, other relationships of measurements at different times can be used for determining various nozzle conditions.

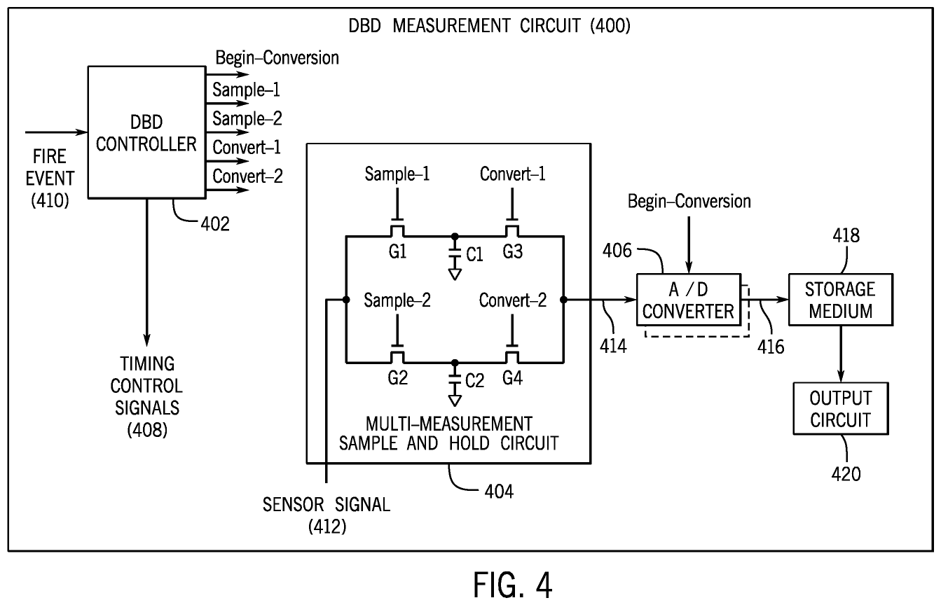

FIG. 4 is a block diagram of a DBD measurement circuit 400 that can be used for performing a DBD evaluation of nozzles of a fluid dispensing device, according to further examples. The DBD measurement circuit 400 includes a DBD controller 402, a multi-measurement sample and hold circuit 404, and an analog-to-digital (A/D) converter 406.

As used here, a “controller” can refer to a hardware processing circuit or a combination of a hardware processing circuit and machine-readable instructions executable on the hardware processing circuit. A hardware processing circuit can include any or some combination of the following: a microprocessor, a core of a multi-core microprocessor, a microcontroller, a programmable integrated circuit, a programmable gate array, or another hardware processing circuit.

The DBD controller 402 can provide timing control signals 408 to nozzles for controlling timings at which respective sensor measurements are taken, such as the peak measurement and the reference measurement noted above. The DBD controller 402 receives a fire event 410, and generates the timing control signals 408 in response to the fire event 410. The timing control signals 408 can cause the sensor 203 of FIGS. 2A-2E to make a first measurement at a first relative time period (e.g., T1) from the fire event 410, and to make a second measurement at a second relative time period (e.g., T2) from the fire event 410.

The DBD controller 402 also provides various control signals for controlling the multi-measurement sample and hold circuit 404 and the A/D converter 406. The control signals from the DBD controller 402 include a Begin-Conversion signal, which causes the A/D converter 406 to begin converting an analog input 414 (which is the output of the sample and hold circuit 404) to a digital output 416.

Other control signals produced by the DBD controller 402 include a Sample-1 signal, which controls the activation of a switch G1 of the sample and hold circuit 404; a Sample-2 signal, which controls the activation of a switch G2 of the sample and hold circuit 404; a Convert-1 signal, which controls the activation of a switch G3 of the sample and hold circuit 404; and a Convert-2 signal, which controls the activation of a switch G4 of the sample and hold circuit 404.

A sensor signal 412 from a nozzle (or from a group of nozzles) is received by the sample and hold circuit 404. Activation of the switch G1 or G2 causes the sensor signal 412 to be propagated through the activated respective switch to a respective storage element C1 or C2. In other words, if the switch G1 is activated by activation of the Sample-1 signal by the DBD controller 402, then a voltage of the sensor signal 412 is passed through the activated switch G1 to the storage element C1 for storage. On the other hand, if the switch G2 is activated by an activation of the Sample-2 signal by the DBD controller 402, then the voltage of the sensor signal 412 is passed through the activated switch G2 to the storage element C2 for storage.

In examples according to FIG. 4, the storage elements C1 and C2 can be implemented as capacitors. In other examples, other types of storage elements C1 and C2 can be used.

The Sample-1 and Sample-2 control signals are to activate the switch G1 while maintaining the switch G2 inactive to provide the first sense measurement to the first storage element C1, and activate the switch G2 while maintaining the switch G1 inactive to provide the second sense measurement to the second storage element C2.

The switches G3 and G4 control when the stored measurements in the storage elements Cl and C2 are propagated to the analog input 414 of the A/D converter 406, based on respective activations of the Convert-1 signal and Convert-2 signal.

The switches G3 and G4 are selectively activatable by the Convert-1 and Convert-2 control signals to alternately couple the first sense measurement stored in the first storage element C1 to the analog input 414 of the ND converter 406, and the second sense measurement stored in the second storage element C2 to the analog input 414 of the ND converter 406.

In alternative examples, multiple ND converters 406 are provided to respectively convert the first and second sense measurements in the respective storage elements C1 and C2. In such alternative examples, the switches G3 and G4 can be omitted.

The digital output 416 of the ND converter 406 can be stored in a storage medium 418 of a fluid dispensing device. For example, the storage medium 418 can be implemented as a non-volatile memory, such as a flash memory or other type of memory. In other examples, the storage medium 418 can be omitted.

The fluid dispensing device further includes an output circuit 420, which can provide the digital output 416 (whether stored in the storage medium 418 or directly from the ND converter 406) to a component that is external of the fluid dispensing device. For example, the output circuit 420 can provide the digital output 416 to a processor of a fluid dispensing system, such as a printer controller of a printing system.

The processor of the fluid dispensing system can then process the digital measurement data collected at multiple time points to determine a health condition of a nozzle (or a group of nozzles).

In other examples, instead of performing the processing for determining the health condition of the nozzle(s) in a processor that is external of the fluid dispensing device, the determination of the health condition of a nozzle(s) can be performed by a processing circuit inside the fluid dispensing device, such as by the DBD controller 402 or a different processor.

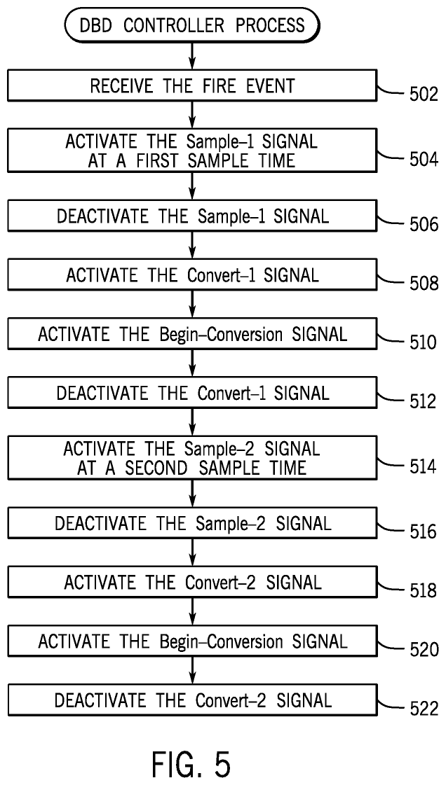

FIG. 5 is a flow diagram of a process of the DBD controller 402, according to some examples. Note that the sequence of tasks of FIG. 5 do not have to be performed in the depicted order, as certain tasks can be performed in other orders in other examples.

Generally, FIG. 5 shows a flow where a first measurement is made, then A/D conversion is performed on the first measurement, then a second measurement is made, and then ND conversion is performed on the second measurement. Alternatively, the first measurement can be stored, then the second measurement can be stored, followed by performing ND conversion of the first measurement and A/D conversion of the second measurement.

The DBD controller 402 receives (at 502) the fire event 410. In response to the fire event 410, the DBD controller 402 activates (at 504) the Sample-1 signal to turn on the switch G1 at a first sample time (relative to the fire event 410). The DBD controller 402 then deactivates (at 506) the Sample-1 signal, to deactivate the switch G1 to complete the sampling of the first voltage of the sensor signal 412 (by storing the first voltage in the storage element C1).

Next, the DBD controller 402 activates (at 508) the Convert-1 signal to activate the switch G3 to provide the stored first measurement in the storage element C1 to the analog input 414 of the A/D converter 406. The DBD controller 402 also activates (at 510) the Begin-Conversion signal to cause the A/D converter 406 to begin converting the first measurement provided through the activated switch G3. The ND converter 406 produces a first digital measurement data, which can be stored in the storage medium 418 or output by the output circuit 420.

The DBD controller 402 deactivates the Begin-Conversion signal a certain amount of time following activation of the Begin-Conversion signal for converting the first measurement in the storage element C1, to allow the A/D converter 406 sufficient time to perform the analog-to-digital conversion.

Once the A/D conversion is complete, the DBD controller 402 deactivates (at 512) the Convert-1 signal to deactivate the switch G3 to decouple the storage element C1 from the ND converter 406.

The DBD controller 402 activates (at 514) the Sample-2 signal to activate the switch G2, at a second sample time relative to the fire event 410.

The DBD controller 402 then deactivates (at 516) the Sample-2 signal to complete the sampling of the second voltage of the sensor signal 412 in the storage element C2.

The DBD controller 402 then activates (at 518) the Convert-2 signal to activate the switch G4 to couple the second sampled measurement in the storage element C2 to the analog input 414 of the A/D converter 406. The DBD controller 402 activates (at 520) the Begin-Conversion signal to cause the A/D converter 406 to convert the second sample measurement into a corresponding digital measurement data.

The DBD controller 402 next deactivates the Begin-Conversion signal some amount of time following the second activation of the Begin-Conversion signal, to give the ND converter 406 sufficient time to perform the A/D conversion of the second sample measurement to the corresponding second digital measurement data.

Once the A/D conversion of the second measurement data is complete, the DBD controller 402 deactivates (at 522) the Convert-2 signal to deactivate the switch G3 to decouple the storage element C1 from the A/D converter 406.

The process of FIG. 5 can be repeated for other nozzles or nozzle groups.

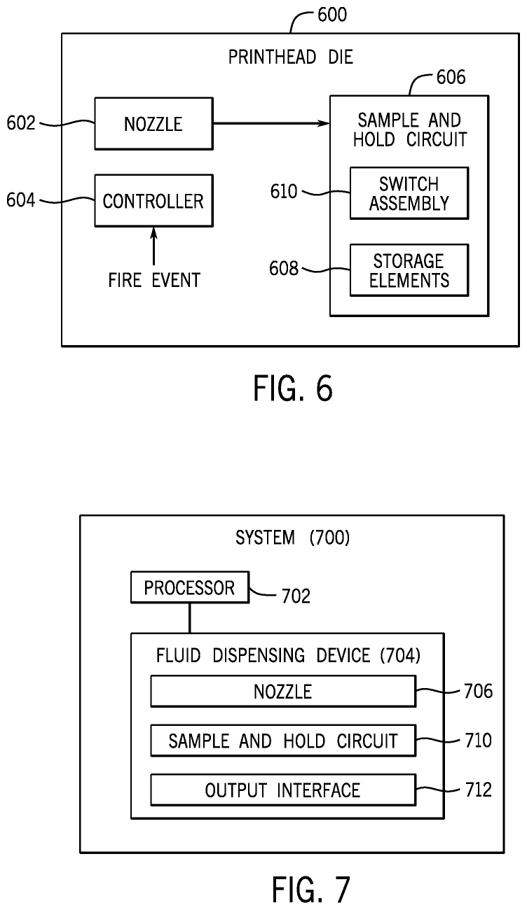

FIG. 6 is a block diagram of a printhead die 600 including a nozzle 602 to dispense a printing fluid, a controller 604, and a sample and hold circuit 606 coupled to the nozzle 602.

The sample and hold circuit 606 includes storage elements 608 and a switch assembly 610 including switches controllable by control signals from the controller 604 to store a first sense measurement of a first condition of the nozzle in a first storage element of the storage elements 608, and store a second sense measurement of a different second condition of the nozzle in a second storage element of the storage elements 608.

The controller 604 is to activate the control signals having respective timing relationships with respect to a given fire event that activates the nozzle 602.

FIG. 7 is a block diagram of a system 700 that includes a processor 702 and a fluid dispensing device 704. The fluid dispensing device 704 includes a nozzle 706, a sample and hold circuit 710 to store a plurality of measurements of respective different conditions of the nozzle in response to a single fire event to activate the nozzle 706, and an output interface 712 to output the plurality of measurements to the processor 702. The processor 702 determines a health of the fluid dispensing device 704 responsive to the plurality of measurements.

In examples where a controller is implemented as a combination of a hardware processing circuit and machine-readable instructions executable on the hardware processing circuit, the machine-readable instructions can be stored in a non-transitory machine-readable or computer-readable storage medium.

The storage medium can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A fluid dispensing device comprising:
storage elements; and
a switch assembly comprising switches controllable by control signals responsive to a given fire event that activates a nozzle of the fluid dispensing device to:
provide a first sense measurement of a first condition of the nozzle to a first storage element of the storage elements, and
provide a second sense measurement of a different second condition of the nozzle to a second storage element of the storage elements.

2. The fluid dispensing device of claim 1, wherein the switches comprise a first switch and a second switch, and the control signals are to activate the first switch while maintaining the second switch inactive to provide the first sense measurement to the first storage element, and activate the second switch while maintaining the first switch inactive to provide the second sense measurement to the second storage element.

3. The fluid dispensing device of claim 1, further comprising:
an analog-to-digital converter to convert the first sense measurement or the second sense measurement into digital data,
wherein the switches are selectively activatable by the control signals to alternately couple the first sense measurement stored in the first storage element to an input of the analog-to-digital converter and the second sense measurement stored in the second storage element to the input of the analog-to-digital converter.

4. The fluid dispensing device of claim 1, further comprising:
a first analog-to-digital converter to convert the first sense measurement stored in the first storage element into digital data.

5. The fluid dispensing device of claim 4, further comprising:
a second analog-to-digital converter to convert the second sense measurement stored in the second storage element into digital data.

6. The fluid dispensing device of claim 4, further comprising:
a storage device to store the digital data.

7. The fluid dispensing device of claim 1, wherein the first sense measurement of the first condition of the nozzle comprises a measurement taken in a first state of the nozzle, and the second sense measurement of the second condition of the nozzle comprises a measurement taken in a different second state of the nozzle.

8. The fluid dispensing device of claim 1, wherein the switches are controllable by the control signals to provide the first sense measurement to the first storage element a first relative time period from the given fire event, and provide the second sense measurement to the second storage element a different second relative time period from the given fire event.

9. The fluid dispensing device of claim 1, wherein the storage elements comprise capacitors.

10. A printhead die comprising:
a nozzle to dispense a printing fluid;
a controller; and
a sample and hold circuit coupled to the nozzle, the sample and hold circuit comprising:
storage elements; and
a switch assembly comprising switches controllable by control signals from the controller to:
store a first sense measurement of a first condition of the nozzle in a first storage element of the storage elements, and
store a second sense measurement of a different second condition of the nozzle in a second storage element of the storage elements,
the controller to activate the control signals having respective timing relationships with respect to a given fire event that activates the nozzle.

11. The printhead die of claim 10, wherein the switches comprise a first switch and a second switch, wherein the control signals comprise a first control signal to activate the first switch a first time period from the given fire event, and a second control signal to activate the second switch a different second time period from the given fire event.

12. The printhead die of claim 11, wherein before an end of the first time period, the second control signal is inactive and the first control signal is active, and wherein after the end of the first time period, the first control signal is inactive and the second control signal is active.

13. The printhead die of claim 10, wherein the first condition of the nozzle corresponds to a drive bubble being present in the nozzle, and the second condition of the nozzle corresponding to the drive bubble not present in the nozzle.

14. A system comprising:
a processor; and
a fluid dispensing device comprising:
a nozzle;
a sample and hold circuit to store a plurality of measurements of respective different conditions of the nozzle in response to a single fire event to activate the nozzle; and
an output interface to output the plurality of measurements to the processor,
wherein the processor is to determine a health of the fluid dispensing device responsive to the plurality of measurements.

15. The system of claim 14, wherein the different conditions comprise a first condition of the nozzle corresponding to a drive bubble being present in the nozzle, and a second condition of the nozzle corresponding to the drive bubble not present in the nozzle.
